(19) United States
(12) Patent Application Publication
(10) Pub. No.: US 2015/0233077 A1
(43) Pub. Date: Aug. 20, 2015

(54) DUAL ROTARY ACTUATOR

(71) Applicant: Jason LINLEY, Fort St. John (CA)

(72) Inventor: Jason LINLEY, Fort St. John (CA)

(21) Appl. No.: 14/623,885

(22) Filed: Feb. 17, 2015

(30) Foreign Application Priority Data
Feb. 17, 2014 (CA) 2842902

(51) Int. Cl. E02D 7/16; F16H 57/025; E02F 3/96

(52) U.S. Cl. CPC E02D 7/16; E02F 3/966; F16H 57/025; F16H 2057/02069

(57) ABSTRACT

A dual rotary actuator includes a housing having an interior cavity that defines a first tubular chamber having a first axis and a second tubular chamber having a second axis. The second axis is perpendicular to the first axis. A first rotating inner core is provided that is concentrically disposed within the first tubular chamber and has a first rotational axis that coaxial with the first axis. A second rotating inner core is provided that is concentrically disposed within the second tubular chamber and has a second rotational axis that coaxial with the second axis. The housing is mounted to a remote end of the excavator boom with the first rotational axis of the first rotating inner core in an orientation which is transverse to a longitudinal axis of the excavator boom. The second rotating inner core provides a mounting for a working tool.

### FIELD

There is described a rotary actuator that was developed for use in attaching a pile driver to an excavator boom, but which may have other have applications.

### BACKGROUND

When a boom excavator is used for driving piles, a pile driver attachment is secured to a standard excavator bucket mounting. This form of attachment has a number of limitations regarding a potential working orientation of the pile driver. There will hereinafter be described a rotary actuator that was developed for use in attaching a pile driver to an excavator boom.

### SUMMARY

There is provided a dual rotary actuator which includes a housing having an interior cavity that defines a first tubular chamber having a first axis and a second tubular chamber having a second axis. The second axis is perpendicular to the first axis. A first rotating inner core is provided that is concentrically disposed within the first tubular chamber and has a first rotational axis that coaxial with the first axis. A second rotating inner core is provided that is concentrically disposed within the second tubular chamber and has a second rotational axis that coaxial with the second axis.

The above described dual rotary actuator can be used to attach a pile driver to an excavator boom by mounting the housing to a remote end of the excavator boom with the first rotational axis the first rotating inner core in an orientation which is transverse to a longitudinal axis of the excavator boom. The second rotating inner core provides a mounting for a working tool.

As will hereinafter be further described in a description of operation and advantages which follows, by selectively rotating the first rotating inner core and the second rotating inner core, piles can be driven at every conceivable angle that an operator may reasonably encounter. A further benefit is that the pile driver can be positioned parallel to the excavator boom for ease of transport.

It will be appreciated that this innovation is not limited to use with a pile driver. The pile driver can be taken off the excavator boom and a drill, a pneumatic hammer, an excavator bucket or another attachment mounted in its place. The ability to function with other attachments will allow the boom excavator to be used for other purposes, when not required for driving piles. The rotary actuator will provide increased torque and a greater degree of rotation than the excavator bucket and most other applications are likely to require.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a dual rotary actuator.

FIG. 2 is a simplified conceptual perspective view of the dual rotary actuator of FIG. 1.

FIG. 3 is a side elevation view of the dual rotary actuator of FIG. 1 attached to a remote end of an excavator boom.

FIG. 4 is a perspective view of the dual rotary actuator of FIG. 1 used to mount a pile driver attachment to an excavator.

FIG. 5, labelled as Prior Art, is a perspective view of a rotary actuator.

FIG. 6, labelled as Prior Art, is a longitudinal section view of the rotary actuator illustrated in FIG. 5.

### DETAILED DESCRIPTION

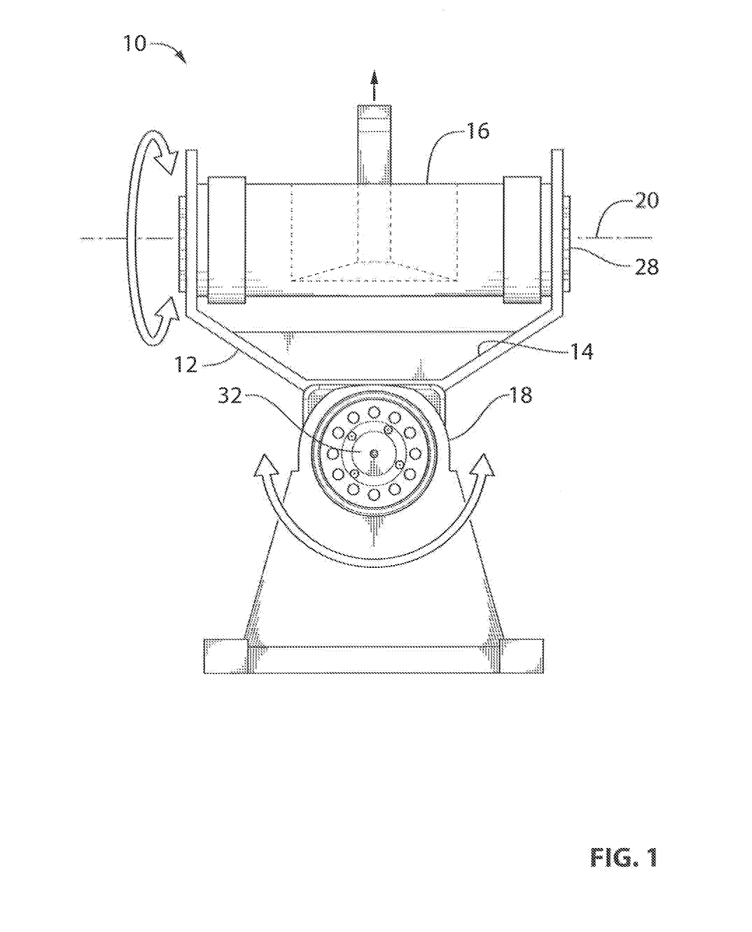

A dual rotary actuator, generally identified by reference numeral 10, will now be described with reference to FIG. 1 through FIG. 6.

Structure and Relationship of Parts:

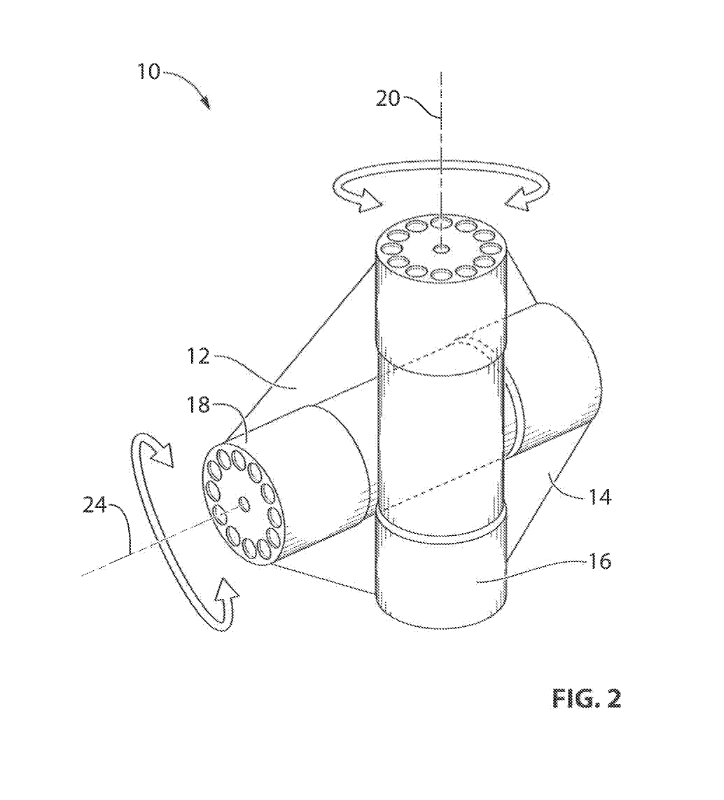

Referring to FIG. 1 and FIG. 2, dual rotary actuator 10 includes a housing 12 having an interior cavity 14 that defines a first tubular chamber 16 and a second tubular chamber 18. First tubular chamber 16 has a first axis 20. Second tubular chamber 18 has a second axis 24. Second axis 24 is slightly offset from and perpendicular to first axis 20. A first rotating inner core 28 is concentrically disposed within first tubular chamber 16 and has a first rotational axis that is coaxial with first axis 20. Second rotating inner core 32 is concentrically disposed within second tubular chamber 18 and has a second rotational axis that is coaxial with second axis 24.

Operation:

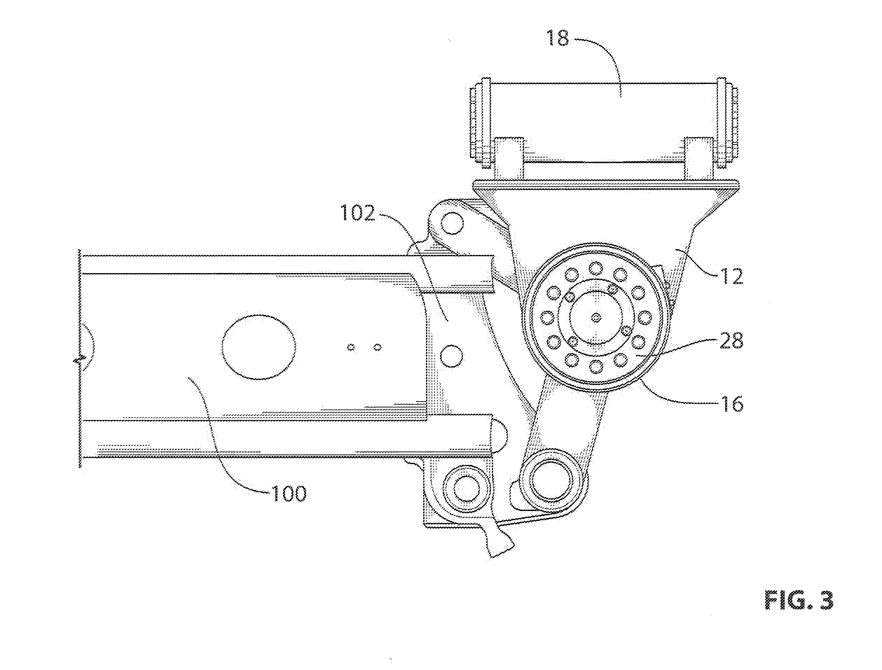

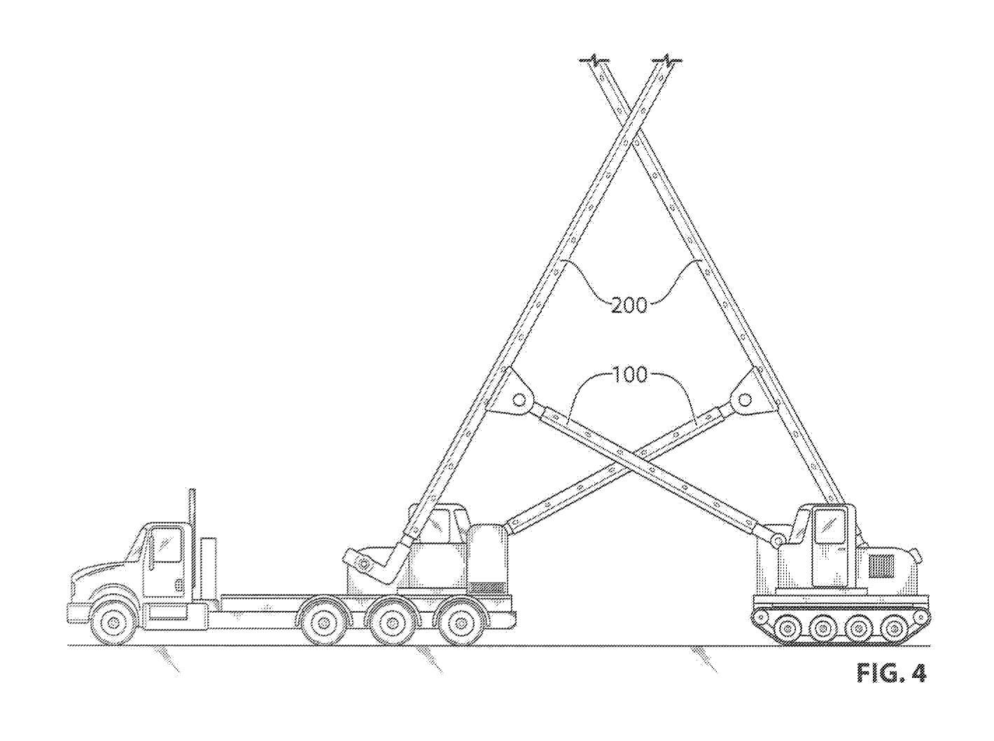

Referring to FIG. 3, in preparation for use, housing 12 is mounted to a remote end 102 of an excavator boom 100 with first rotational axis 30 of first rotating inner core 28 in an orientation which is transverse to a longitudinal axis 104 of excavator boom 100. It will be appreciated that this transverse positioning may be vertical, horizontal or some angular position in between. For the purpose of illustration, the orientation has been shown as positioning first tubular chamber 16 in a horizontal orientation. Second rotating inner core 32 provides a mounting for a working tool. Referring to FIG. 4 a pile driver 200 has been illustrated as the working tool. In the illustrated orientation, rotation of first rotating inner core 28 of dual rotary actuator 10 moves pile driver 200 about excavator boom 100 on an arcuate path which defines a vertical plane. Upward rotation is limited when pile driver 200 is positioned parallel to top of excavator boom 100. Downward rotation is limited when an obstacle is encountered. If a smaller tool were used, downward rotation would also be limited When pile driver 200 was positioned parallel to bottom of excavator boom 100. In the illustrated orientation, rotation of second rotating inner core 32 rotates pile driver 200 on a horizontal plane from left side to right side of excavator boom 100. It will be appreciated that by selectively rotating first rotating inner core 28 and the second rotating inner core 32, pile driver 200 can be positioned at every conceivable angle relative to excavator boom 100.

Prior Art Rotary Actuator

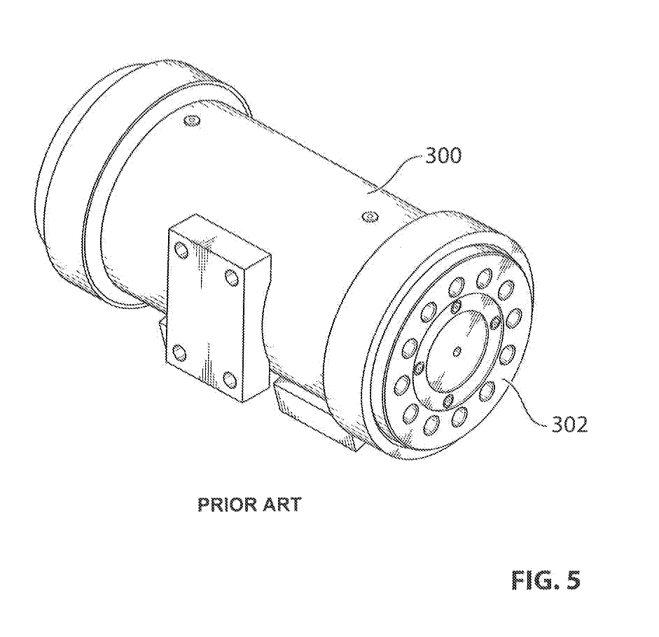

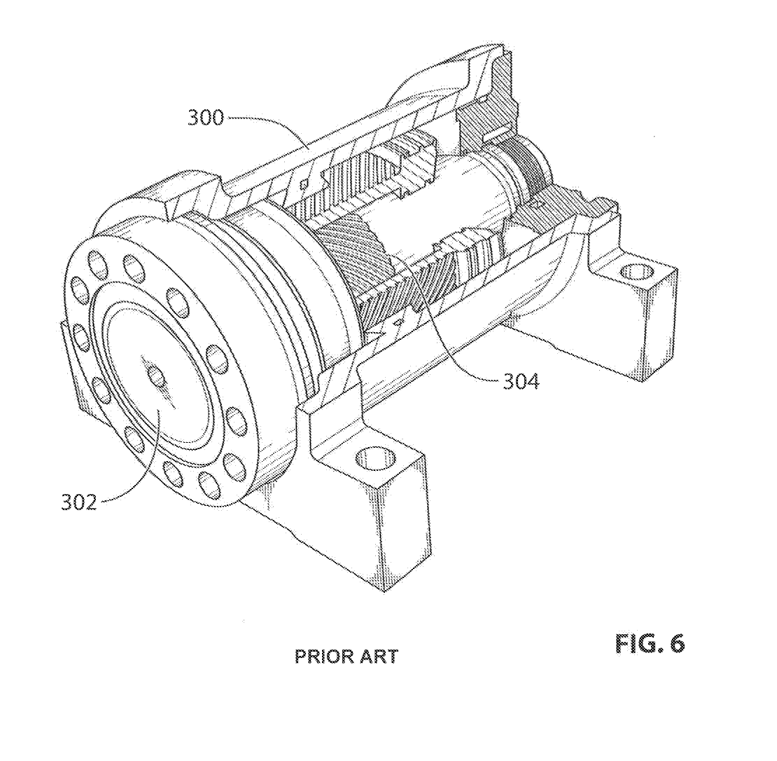

Referring to FIG. 5, in constructing dual rotary actuator 10, some prior art technology was used. Referring to FIG. 6, a section view has been provided of an individual rotary actuator 300. From this view it can be seen that rotating inner core 302 of rotary actuator 300 is caused to rotate through a planetary gear assembly, generally indicated by reference numeral 304.

Advantages:

It will be appreciated that piles can be driven at every conceivable angle that an operator may reasonably encounter and pile driver 200 can be positioned parallel to the excavator boom for ease of transport. It will be appreciated that pile driver 200 can be taken off excavator boom 100 and an excavator bucket or other tool mounted in its place. The excavator bucket will not require the same degree of rotation. However, it is to be noted that the ability to function with an excavator bucket or other tool will allow boom excavator 100 to be used for other purposes when not required for driving piles.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A dual rotary actuator, comprising:
a housing having an interior cavity that defines a first tubular chamber having a first axis and a second tubular chamber having a second axis, the second plane axis being perpendicular to the first axis;
a first rotating inner core that is concentrically disposed within the first tubular chamber and has a first rotational axis that coaxial with the first axis; and
a second rotating inner core that is concentrically disposed within the second tubular chamber and has a second rotational axis that coaxial with the second axis.

2. The dual rotary actuator of claim 1 in combination with an excavator boom, wherein the housing is mounted to a remote end of the excavator boom with the first rotational axis the first rotating inner core in an orientation which is transverse to a longitudinal axis of the excavator boom and the second rotating inner core provides a mounting for a working tool.
